(19) United States
(12) Patent Application Publication
(10) Pub. No.: US 2021/0326318 A1
(43) Pub. Date: Oct. 21, 2021

(54) METHOD AND SYSTEM FOR KEYWORD SEARCH OVER A KNOWLEDGE GRAPH

(71) Applicant: Robert Bosch GmbH, Stuttgart (DE)

(72) Inventor: Evgeny Kharlamov, Muenchen (DE)

(21) Appl. No.: 17/228,192

(22) Filed: Apr. 12, 2021

(30) Foreign Application Priority Data
Apr. 16, 2020 (EP) 20169776.0

(51) Int. Cl. G06F 16/22; G06F 16/242; G06F 16/28; G06N 5/02

(52) U.S. Cl. CPC G06F 16/2246; G06N 5/022; G06F 16/285; G06F 16/242

(57) ABSTRACT

A computer implemented method for enhancing a knowledge graph with labels, wherein a knowledge graph comprises a large number of vertices representing entities and a large number of edges representing relations between the entities. The method comprises determining a label for each vertex, wherein the label of each vertex comprises a list of distances between said particular vertex and other vertices of the knowledge graph, wherein the distances are sorted in descending order with regard to betweenness centrality of the vertices, starting with a distance to a vertex with the highest number of edges pointing in and out of the vertex.

### CROSS REFERENCE

The present application claims the benefit under 35 U.S.C. § 119 of European Patent Application No. EP 20169776.0 filed on Apr. 16, 2020, which is expressly incorporated herein by reference in its entirety.

### FIELD

The present invention relates to a computer implemented method and a system for enhancing a knowledge graph with labels. Further, the present invention relates to the use of said method and/or said system in a method and/or in a system for keyword search over a knowledge graph.

### BACKGROUND INFORMATION

Keyword search allows users to query data without a prior knowledge of specialized query languages. A keyword query is a set of words posed by the user that should be matched to the data. Relevant data fragments are then extracted and presented to the user in an appropriate format as answers. The exact way of matching keywords, extracting data, and composing answers depends on the format of the underlying data and the semantics of query answering.

Knowledge graphs are mainly used for graph-based knowledge representation by describing (real world) entities and their relations. A knowledge graph comprises a large number of vertices representing the entities and a large number of edges representing the relations between the entities.

A common type of semantics for keyword queries over graph data is to match each keyword to a vertex of the graph and to extract trees of minimum weight that contain these vertices, known as minimum-weight Steiner trees as described in Stefan Voß. 1992. “Steiner's Problem in Graphs: Heuristic Methods.” Discr. Appl. Math. 40, 1 (1992), 45-72.

In an edge-weighted data graph and a keyword query, one firstly finds for each keyword the matching set of vertices in the graph, i.e., all the vertices where the keyword can be matched, and then finds a tree in the graph that spans the matching sets, i.e., contains at least one vertex from each matching set, and that minimizes the total edge weight. This optimization problem is the group Steiner tree (GST) problem as described in Stefan Voß. 1992. “Steiner's Problem in Graphs: Heuristic Methods.” Discr. Appl. Math. 40, 1 (1992), 45-72. Keywords are also allowed to be matched to edges. Edge matches can be straightforwardly transformed into vertex matches via graph subdivision, and be processed as vertex matches.

Computing answers to keyword queries under the GST semantics is computationally demanding. Moreover, existing approximation algorithms that have provable quality guarantees also have prohibitively high run time for large graphs. Knowledge graphs have become increasingly popular in recent years, and they can be huge. One goal of the present invention is to provide efficient keyword search systems and methods over knowledge graphs.

### SUMMARY

This may achieved by the device and methods according to example embodiments of the present invention.

According to an example embodiment of the present invention, a computer implemented method is provided for enhancing a knowledge graph with labels, wherein a knowledge graph comprises a large number of vertices representing entities and a large number of edges representing relations between said entities, wherein the method comprises a step of determining a label for each vertex, wherein the label of each vertex comprises a list of distances between said particular vertex and other vertices of the knowledge graph, wherein the distances are sorted in descending order with regard to betweenness centrality of the vertices, starting with a distance to a vertex with the highest number of edges pointing in and out of said vertex.

The labels are offline constructed index structure and can therefore be called static labels.

The betweenness centrality be of a vertex v is defined as

$$bc ( v ) = {\sum }_{s , t ∈ V ∖ \{ v \}} \frac{{σ}_{s t} ( v )}{{σ}_{s t}} ,$$

where σₛₜ is the number of shortest paths between vertices s and t, and σₛₜ(v) is the number of the paths σₛₜ that pass through the vertex v. The betweenness centrality can be computed using the Brandes algorithm as described in Ulrik Brandes: 2001, “A faster algorithm for betweenness centrality” J. Math. Soc. 25, 2 (2001), 163-177. However, for large graphs the Brandes algorithm can cause high run times. Therefore, the use of a source sampling based approximation algorithm and starting with a vertex with the highest number of edges pointing in and out of said vertex has proved to be advantageous. Further details of this algorithm are described in Ziyad AlGhamdi, Fuad Jamour, Spiros Skiadopoulos, and Panos Kalnis, 2017: “A Benchmark for Betweenness Centrality Approximation Algorithms on Large Graphs,” https://doi.org/10.1145/3085504.3085510.

The further processing of labels will be faster if vertices have smaller materialized labels. A conventional implementation of a heuristic method for constructing reasonably small labels for a given graph is for example the pruned landmark labelling (PLL), as described in Takuya Akiba, Yoichi Iwata, and Yuichi Yoshida, 2013: “Fast exact shortest-path distance queries on large networks by pruned landmark labelling,” 349-360, https://doi.org/10.1145/2463676.2465315, which performs the Dijkstra algorithm and effectively prunes searches to reduce labels. The computer implemented method according to the present invention improves the pruned landmark labelling (PLL) to obtain smaller labels and hence provides faster processing of the labels.

According to an example embodiment of the present invention, the distance between a pair of vertices is the sum of weights of the edges connecting the pair of vertices. Weights are non-negative real numbers mapped to edges using a weighting function. For example, small weights indicate great importance and high weights indicate a low importance.

According to an example embodiment of the present invention, the method comprises further a step for computing distances between vertices of the knowledge graph. The distance between a pair of vertices can be computed by summing up the weights of the edges connecting the pair of vertices.

According to an example embodiment of the present invention, a distance is computed by computing the smallest distance between a pair of vertices.

According to an example embodiment of the present invention, the label of each vertex comprises further information on the predecessors of the vertex. Each adjacent vertex of the vertex gives a predecessor of a vertex. Storing the predecessors does not increase the asymptotic space complexity of the static labels.

The present invention further provides a computer program for enhancing a knowledge graph with labels, wherein the computer program comprises computer readable instructions that when executed by a computer cause the computer to execute a method for enhancing a knowledge graph with labels according to the embodiments. Advantageously, the computer program comprises instructions that when executed by a computer cause the computer to execute a step of determining a label for each vertex, wherein the label of each vertex comprises a list of distances between said particular vertex and other vertices of the knowledge graph, wherein the distances are sorted in descending order with regard to betweenness centrality of the vertices, starting with a distance to a vertex with the highest number of edges pointing in and out of said vertex.

Advantageously, in accordance with an example embodiment of the present invention, the computer program comprises instructions that when executed by a computer cause the computer to execute a step of computing distances between vertices of the knowledge graph.

The present invention further provides a system for enhancing a knowledge graph with labels, wherein the system comprises at least one memory unit for storing said knowledge graph and/or least one memory unit for storing a computer program, wherein said computer program controls the execution of a method for enhancing a knowledge graph with labels according to the embodiments. The system can be configured to access distributed storing units.

The labels of the knowledge graph may be stored in the same storing unit as the knowledge graph. According to an embodiment, the system comprises further a memory unit for storing the labels.

The present invention further provides a method for keyword search over a knowledge graph, wherein the knowledge graph comprises a large number of vertices representing entities and a large number of edges representing relations between said entities, and the knowledge graph is enhanced with labels by using a method for enhancing a knowledge graph with labels according to the embodiments and/or a system for enhancing a knowledge graph with labels according the embodiments and/or a computer program for enhancing a knowledge graph with labels according to the embodiments, wherein the method for keyword search comprises the steps of receiving a set of keywords and determining a subgraph for the set of keywords, wherein the step of determining the subgraph comprises: mapping keywords of the set of keywords to vertices of the knowledge graph, and determining the shortest path between each pair of said vertices based on the labels of the vertices, such that the subgraph of the knowledge graph is minimal with regard to distances between said vertices.

The labels are constructed offline and are therefore invariant to the search queries.

According to an example embodiment of the present invention, the step of determining the shortest path between a pair of vertices comprises determining common vertices for the pair of vertices by using the information on predecessors of the vertices in the labels.

According to an example embodiment of the present invention, the step of determining the shortest path between each pair of vertices comprises repeatedly following the predecessors stored in the labels of the vertices.

According to another example embodiment of the present invention, the method can be advantageously extended to support edge matches by mapping keywords of the set of keywords to edges of the knowledge graph.

According to an example embodiment of the present invention, edges are transformed into vertices using graph sub division. The subdivision of an edge yields a new vertex and replaces the edge by two new edges. In this way, edge matches are transformed into vertex matches. Advantageously, the steps described with regard to mapping keywords to vertices can be performed with regard to edges.

The present invention further provides a computer program for keyword search over a knowledge graph, wherein the computer program comprises computer readable instructions that when executed by a computer cause the computer to execute a method for keyword search over a knowledge graph according to the embodiments.

Advantageously, in accordance with an example embodiment of the present invention, the computer program comprises instructions that when executed by a computer cause the computer to execute any of the steps of receiving a set of keywords and determining a subgraph for the set of keywords, wherein the step of determining the subgraph comprises: mapping keywords of the set of keywords to vertices of the knowledge graph, and determining the shortest path between each pair of said vertices based on the labels of the vertices, such that the subgraph of the knowledge graph is minimal with regard to distances between said vertices.

Advantageously, in accordance with an example embodiment of the present invention, the computer program comprises instructions that when executed by a computer cause the computer to execute the step of determining common vertices for the pair of vertices by using the information on predecessors of the vertices in the labels.

Advantageously, in accordance with an example embodiment of the present invention, the computer program comprises instructions that allows extending the method to support edge matches.

The present invention further provides a system for keyword search over a knowledge graph, wherein the system is configured to execute a method for keyword search over a knowledge graph according to the embodiments.

According to an example embodiment of the present invention, the system for keyword search over a knowledge graph comprises at least one memory unit for storing a set of keywords and/or least one memory unit for storing a computer program for keyword search over a knowledge graph, wherein said computer program PRG 2 controls the execution of the method for keyword search over a knowledge graph according to the embodiments.

Advantageously, in accordance with an example embodiment of the present invention, the system comprises a storing unit for storing a knowledge graph and/or a storing unit for storing a computer program for keyword search over a knowledge graph according to the embodiments.

Further advantageous embodiments of the present invention are derived from the following description and the figures.

### BRIEF DESCRIPTION OF THE DRAWINGS

FIG. 1 depicts a schematic view of a computer implemented method for enhancing a knowledge graph with labels according to an example embodiment of the present invention.

FIG. 2 depicts a schematic view of a knowledge graph, in accordance with an example embodiment of the present invention.

FIG. 3 depicts a schematic view of a system for enhancing a knowledge graph with labels according to an example embodiment of the present invention.

FIG. 4 depicts a schematic view of a computer implemented method for keyword search over a knowledge graph according to an example embodiment of the present invention.

FIG. 5 depicts a schematic view of a system for keyword search over a knowledge graph according to an example embodiment of the present invention.

### DETAILED DESCRIPTION OF EXAMPLE EMBODIMENTS

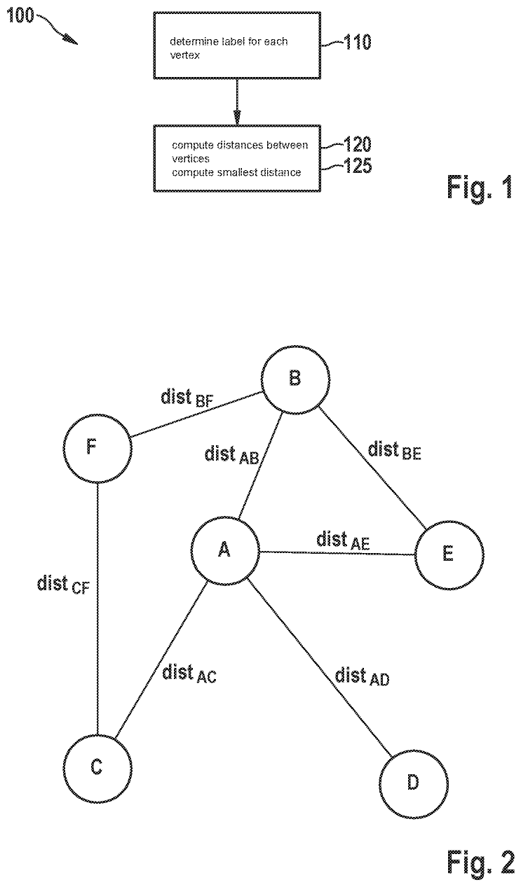

FIG. 1 shows a computer implemented method 100 for enhancing a knowledge graph with labels. An exemplary presentation of a knowledge graph KG is given by FIG. 2. The knowledge graph KG can be used for graph-based knowledge representation by describing (real world) entities and their relations. The knowledge graph KG comprises a large number of vertices V representing the entities and a large number of edges E representing the relations between said entities.

According to an example embodiment, the method 100 for enhancing the knowledge graph KG with labels L comprises

a step 110 of determining a label L for each vertex V, wherein the label L of each vertex V comprises a list of distances between said particular vertex V and other vertices V of the knowledge graph KG.

As shown in FIG. 2, the knowledge graph KG comprises vertices A, B, C, D, E and F. The distance between the vertices are for example dist_{AB}=0.6, dist_{AC}=0.4, dist_{AD}=1, dist_{AE}=0.3, dist_{BE}=0.8, dist_{BF}=0.1 and dist_{CF}=2.

The following table gives an exemplary presentation of labels L:

| | |
|---|---|
| L(A) | A (dist = 0, pred = A) |
| L(B) | A (dist = 0.6, pred = A), B (dist = 0, pred = B) |
| L(C) | A (dist = 0.4, pred = A), C (dist = 0, pred = C) |
| L(D) | A (dist = 1, pred = A), D (dist = 0, pred = D) |
| L(E) | A (dist = 0.3, pred = A), B (dist = 0.8, pred = B), E (dist = 0, |
| | pred = E) |
| L(F) | A (dist = 0.7, pred = B), B (dist = 0.1, pred = B), F (dist = 0, |
| | pred = F) |

The distances are sorted in descending order with regard to betweenness centrality of the vertices, starting with a distance to a vertex with the highest number of edges pointing in and out of said vertex.

The betweenness centrality be of a vertex v is defined as

$$bc ( v ) = {\sum }_{s , t ∈ V ∖ \{ v \}} \frac{{σ}_{s t} ( v )}{{σ}_{s t}} ,$$

where σₛₜ is the number of shortest paths between vertices s and t, and σₛₜ(v) is the number of the paths σₛₜ that pass through the vertex v. According to the present invention, the betweenness centrality is using a source sampling based approximation algorithm and starting with a vertex with the highest number of edges pointing in and out of said vertex. Further details of this algorithm are described in Ziyad AlGhamdi, Fuad Jamour, Spiros Skiadopoulos, and Panos Kalnis, 2017: “A Benchmark for Betweenness Centrality Approximation Algorithms on Large Graphs,” https://doi.org/10.1145/3085504.3085510.

According to an example embodiment, the distance between a pair of vertices is the sum of weights of the edges E connecting the pair of vertices V. Weights are non-negative real numbers mapped to edges E using a weighting function. For example, small weights indicate great importance and high weights indicate a low importance.

According to an example embodiment, the method comprises further a step 120 for computing distances between vertices V of the knowledge graph KG. The distance between a pair of vertices V can be computed by summing up the weights of the edges E connecting the pair of vertices V.

According to an example embodiment, a distance is computed by computing 125 the smallest distance between a pair of vertices V.

According to an example embodiment, the label L of each vertex V comprises further information on the predecessors of the vertex V. Each adjacent vertex V of a specific vertex V gives a predecessor of a vertex V.

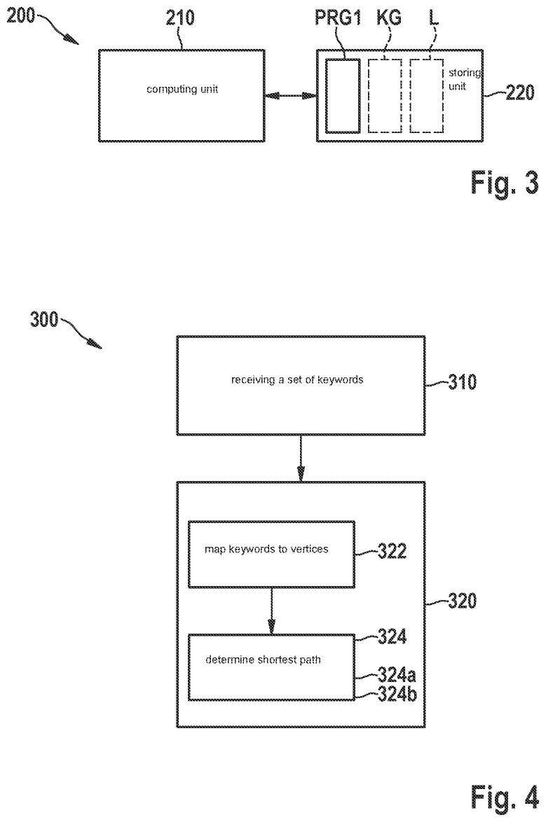

FIG. 3 depicts a schematic view of a system 200 for enhancing a knowledge graph KG with labels L according to an example embodiment.

The system 200 is configured to carry out at least the steps 110, 120 and 125 of the method 100.

The system 200 comprises a computing unit 210, e.g. a microprocessor and/or microcontroller and/or programmable logic device, in particular FPGA, and/or application-specific integrated circuit, ASIC, and/or digital signal processor, DSP, and/or a combination thereof.

The system 200 comprises at least one storing unit 220. The storing unit 220 may further comprise a volatile memory, in particular random access memory (RAM), and/or a non-volatile memory, e.g. a flash EEPROM. The storing unit 220 contains at least one computer program PRG1 for the computing unit 210, which controls the execution of the method 100 for enhancing the knowledge graph KG with labels L according to the embodiments and/or any other operation of the system 200.

The system 200 may further comprise an interface unit 230 for receiving data constituting the knowledge graph KG from at least one external data source. The data constituting the knowledge graph can be stored in the storing unit 220 of the system or in a further, for example an external, storing unit.

According to an example embodiment, the labels L are stored in the same storing unit as the knowledge graph KG, for example in the storing 220 or in an external storing unit. According to another embodiment, the labels L are stored in a separate storing unit.

The computer program PRG1 advantageously comprises computer readable instructions that when executed by a computer, preferably the computing unit 210, cause the computer to execute the method 100 for enhancing a knowledge graph with labels according to the embodiments. Advantageously, the computer program PRG1 comprises instructions that when executed by a computer cause the computer to execute the step 110 of determining a label L for each vertex V of the knowledge graph KG, wherein the label L of each vertex V comprises a list of distances between said particular vertex V and other vertices V of the knowledge graph KG, wherein the distances are sorted in descending order with regard to betweenness centrality of the vertices V, starting with a distance to a vertex V with the highest number of edges E pointing in and out of said vertex V.

Advantageously, the computer program PRG1 comprises instructions that when executed by a computer cause the computer to execute the step 120 of computing distances between vertices V of the knowledge graph KG.

FIG. 4 depicts a schematic view of a computer implemented method 300 for keyword search over the knowledge graph KG according to another embodiment of the present invention. Keyword search allows users to query data without a prior knowledge of specialized query languages. A keyword query is a set of words posed by the user that should be matched to the data.

According to an example embodiment, the knowledge graph KG is enhanced with labels L by using the method 100 for enhancing the knowledge graph KG with labels L according to the above described embodiments and/or the system 200 for enhancing the knowledge graph KG with labels L according to the above described embodiments and/or the computer program PRG 1 for enhancing the knowledge graph KG with labels L according to the above described embodiments.

According to FIG. 4 the method 300 comprises

a step 310 of receiving a set of keywords and

a step 320 of determining a subgraph for the set of keywords.

According to the embodiment the step 320 of determining the subgraph comprises

a step 322 of mapping keywords of the set of keywords to vertices V of the knowledge graph KG, and

a step 324 of determining the shortest path between each pair of said vertices V based on the labels L of the vertices V, such that the subgraph of the knowledge graph KG is minimal with regard to distances between said vertices V.

According to the example embodiment, the step 324 of determining the shortest path between a pair of vertices V comprises determining 324a common vertices V for the pair of vertices V by using the information on predecessors of the vertices V in the labels L.

According to the example embodiment, the step 324 of determining the shortest path between each pair of vertices V comprises repeatedly following 324b the predecessors stored in the labels L of the vertices V.

According to an example embodiment, the method 300 may further comprise mapping keywords of the set of keywords to edges E of the knowledge graph KG. According to an embodiment, edges E are transformed into vertices V using graph sub division. The subdivision of an edge E yields a new vertex V and replaces the edge E by two new edges E. In this way, edge matches are transformed into vertex matches. Advantageously, the steps 320, 322, 324, 324a, 324b of the method 300, described with regard to mapping keywords to vertices V can be performed with regard to edges E.

The method 300, in particular the steps 324, 324a and 324b, is described below exemplarily with regard to FIG. 2.

The knowledge graph KG is extended with labels L, as shown in above table.

To obtain a shortest path (step 324) between two vertices V, firstly the common vertex V between these two vertices V is determined (step 324a) and secondly the predecessors of the two vertices V are followed to construct the part from one vertex V to the common vertex V and to construct the part from the other vertex V to the common vertex V.

For example, to compute the shortest path between vertices D and F, A is determined as common vertex between D and F. This information can be obtained from the labels of the vertices D and D. A is the only common vertex in L(D) and L(F). The D-A part of the path between D and F, the single edge (D,A), is constructed by following pred(D,A)=A which is stored with A in L(D). The F-A part of the path between D and F, the path consisting of two edges (F, B) and (B,A), is constructed by following pred(F,A)=B which is stored with A in L(F) and then following pred(B,A)=A which is stored with A in L(B). Finally, the two parts are concatenated into the shortest path between D and F, which is p=D-A-B-F.

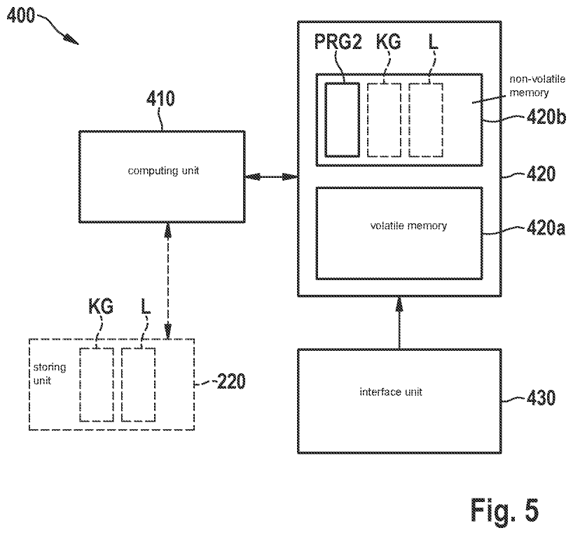

FIG. 5 depicts a schematic view of a system 400 for keyword search over the knowledge graph KG according to an example embodiment.

The system 400 is configured to carry out at least the steps 310, 320 of the method 300.

The system 400 comprises a computing unit 410, e.g. a microprocessor and/or microcontroller and/or programmable logic device, in particular FPGA, and/or application-specific integrated circuit, ASIC, and/or digital signal processor, DSP, and/or a combination thereof.

The system 400 comprises at least one storing unit 420. The storing unit 420 may further comprise a volatile memory 420a, in particular random access memory (RAM), and/or a non-volatile memory 420b, e.g. a flash EEPROM. The non-volatile memory 420b contains at least one computer program PRG2 for the computing unit 410, which controls the execution of the method 300 for keyword search over the knowledge graph KG according to the embodiments and/or any other operation of the system 400.

The system 400 may further comprise an interface unit 430 for receiving data constituting the set of keywords. The set of keywords can be stored in said volatile memory 420a of said storing unit 420.

The system 400 may further comprise a storing unit for storing the knowledge graph KG and/or the labels L of the 12nowledge graph KG. According to another embodiment the system 400 is configured to access a storing unit comprising the knowledge graph KG and/or labels L of the knowledge graph KG, for example an external storing unit. The external storing unit is for example the storing unit 220 of the system 200 as depicted in FIG. 3.

The computer program PRG2 for keyword search over the knowledge graph KG, comprises computer readable instructions that when executed by a computer, preferable the computing unit 410 of the system 400, cause the computer to execute the method 300 for keyword search over a knowledge graph KG according to the above described embodiments.

Advantageously, the computer program PRG2 comprises instructions that when executed by a computer cause the computer to execute any of the steps of receiving 310 a set of keywords and determining 320 a subgraph for the set of keywords, wherein the step 320 of determining the subgraph comprises: mapping 322 keywords of the set of keywords to vertices V of the knowledge graph KG, and determining 324 the shortest path between each pair of said vertices V based on the labels L of the vertices V, such that the subgraph of the knowledge graph KG is minimal with regard to distances between said vertices V.

Advantageously, the computer program PRG2 comprises instructions that when executed by a computer cause the computer to execute the step 324a of determining common vertices V for the pair of vertices V by using the information on predecessors of the vertices V in the labels L.

Advantageously, the computer program PRG2 comprises instructions that allows extending the method 300 to support edge matches.

What is claimed is:

1. A computer implemented method for enhancing a knowledge graph with labels, wherein the knowledge graph includes a large number of vertices representing entities and a large number of edges representing relations between the entities, the method comprising:
determining a label for each vertex of the vertices, wherein the label of each vertex includes a list of distances between the vertex and other vertices of the knowledge graph, wherein the distances are sorted in descending order with regard to betweenness centrality of the vertices, starting with a distance to a vertex with a highest number of edges pointing in and out of the vertex.

2. The computer implemented method according to claim 1, wherein the distance between a pair of the vertices is a sum of weights of edges connecting the pair of the vertices.

3. The computer implemented method according to claim 1, further comprising:
computing distances between vertices of the knowledge graph.

4. The computer implemented method according to claim 1, wherein each distance of the distances is computed by computing a smallest distance between a pair of the vertices.

5. The computer implemented method according to claim 1, wherein the label of each vertex includes further information on predecessors of the vertex.

6. A non-transitory computer-readable storage medium on which is stored a computer program for enhancing a knowledge graph with labels, wherein the knowledge graph includes a large number of vertices representing entities and a large number of edges representing relations between the entities, the computer program, when executed by a computer, causing the computer to perform:
determining a label for each vertex of the vertices, wherein the label of each vertex includes a list of distances between the vertex and other vertices of the knowledge graph, wherein the distances are sorted in descending order with regard to betweenness centrality of the vertices, starting with a distance to a vertex with a highest number of edges pointing in and out of the vertex.

7. A system for enhancing a knowledge graph with labels, wherein the system comprises at least one memory unit for storing the knowledge graph and/or least one non-transitory memory unit on which is stored a computer program for the enhancing of the knowledge graph with the labels, wherein the knowledge graph includes a large number of vertices representing entities and a large number of edges representing relations between the entities, and wherein the computer program, when executed by a computer, causing the computer to perform:
determining a label for each vertex of the vertices, wherein the label of each vertex includes a list of distances between the vertex and other vertices of the knowledge graph, wherein the distances are sorted in descending order with regard to betweenness centrality of the vertices, starting with a distance to a vertex with a highest number of edges pointing in and out of the vertex.

8. The system according to claim 7, further comprising:
a memory unit for storing the labels of the vertices.

9. A computer implemented method for keyword search over a knowledge graph,
wherein the knowledge graph includes a large number of vertices representing entities and a large number of edges representing relations between the entities, and the knowledge graph is enhanced with labels by determining a label for each vertex of the vertices, wherein the label of each vertex includes a list of distances between the vertex and other vertices of the knowledge graph, wherein the distances are sorted in descending order with regard to betweenness centrality of the vertices, starting with a distance to a vertex with a highest number of edges pointing in and out of the vertex, the method comprising the following steps:
receiving a set of keywords; and
determining a subgraph for the set of keywords, wherein the step of determining the subgraph includes:
mapping keywords of the set of keywords to the vertices of the knowledge graph, and
determining a shortest path between each pair of the vertices based on the labels of the vertices, such that the subgraph of the knowledge graph is minimal with regard to distances between the vertices.

10. The computer implemented method according to claim 9, wherein the step of determining the shortest path between each pair of vertices includes determining common vertices for the pair of vertices by using information on predecessors of the vertices in the labels of the vertices.

11. The computer implemented method according to claim 9, wherein the step of determining the shortest path between each pair of vertices includes repeatedly following predecessors stored in the labels of the vertices.

12. The computer implemented method according to claim 9, wherein the method further comprises:
mapping keywords of the set of keywords to edges of the knowledge graph.

13. The computer implemented method according to claim 12, wherein the edges of the knowledge graph are transformed into vertices using graph sub division.

14. A non-transitory computer readable storage medium on which is stored a computer program for keyword search over a knowledge graph, wherein the knowledge graph includes a large number of vertices representing entities and a large number of edges representing relations between the entities, and the knowledge graph is enhanced with labels by determining a label for each vertex of the vertices, wherein the label of each vertex includes a list of distances between the vertex and other vertices of the knowledge graph, wherein the distances are sorted in descending order with regard to betweenness centrality of the vertices, starting with a distance to a vertex with a highest number of edges pointing in and out of the vertex, the computer program, when executed by a computer, causing the computer to perform the following steps:
receiving a set of keywords; and
determining a subgraph for the set of keywords, wherein the step of determining the subgraph includes:
mapping keywords of the set of keywords to the vertices of the knowledge graph, and
determining a shortest path between each pair of the vertices based on the labels of the vertices, such that the subgraph of the knowledge graph is minimal with regard to distances between the vertices.

15. A system for keyword search over a knowledge graph, wherein the system comprises at least one memory unit for storing a set of keywords and/or least one non-transitory memory unit on which is stored a computer program for the keyword search over the knowledge graph, for keyword search over a knowledge graph, wherein the knowledge graph includes a large number of vertices representing entities and a large number of edges representing relations between the entities, and the knowledge graph is enhanced with labels by determining a label for each vertex of the vertices, wherein the label of each vertex includes a list of distances between the vertex and other vertices of the knowledge graph, wherein the distances are sorted in descending order with regard to betweenness centrality of the vertices, starting with a distance to a vertex with a highest number of edges pointing in and out of the vertex, when the computer program, when executed by a computer, causes the computer to perform the following steps:
receiving a set of keywords; and
determining a subgraph for the set of keywords, wherein the step of determining the subgraph includes:
mapping keywords of the set of keywords to the vertices of the knowledge graph, and
determining a shortest path between each pair of the vertices based on the labels of the vertices, such that the subgraph of the knowledge graph is minimal with regard to distances between the vertices.
